(19) United States
(12) Patent Application Publication
(10) Pub. No.: US 2006/0274452 A1
(43) Pub. Date: Dec. 7, 2006

(54) Method for utilizing a suspension flexure polyimide material web to dampen a flexure nose portion of a head gimbal assembly

(76) Inventor: Satya Prakash Arya, San Jose, CA (US)

Correspondence Address: WAGNER, MURABITO & HAO LLP;Third Floor, Two North Market Street, San Jose, CA, 95113, US

(21) Appl. No.: 11/144,001

(22) Filed: Jun. 2, 2005

(51) Int. Cl. G11B 5/48

(52) U.S. Cl. 360/245.3

(57) ABSTRACT

A method for extending and utilizing a web made out of existing flexure base material polyimide to dampen a flexure nose portion of a head gimbal assembly is disclosed. The method provides a slider coupled with the head gimbal assembly, the slider having a read/write head element thereon. In addition, a flexure nose portion is coupled with the head gimbal assembly. A suspension flexure polyimide material web is provided between the flexure nose portion and the head gimbal assembly for damping said flexure nose portion.

### TECHNICAL FIELD

The present invention relates to the field of hard disk drive development, and more particularly to a method for utilizing a suspension flexure polyimide material web to dampen a flexure nose portion of a head gimbal assembly.

### BACKGROUND ART

Hard disk drives are used in almost all computer system operations. In fact, most computing systems are not operational without some type of hard disk drive to store the most basic computing information such as the boot operation, the operating system, the applications, and the like. In general, the hard disk drive is a device which may or may not be removable, but without which the computing system will generally not operate.

The basic hard disk drive model was established approximately 50 years ago and resembles a phonograph. That is, the hard drive model includes a storage disk or hard disk that spins at a standard rotational speed. An actuator arm with a suspended slider is utilized to reach out over the disk. The arm carries an assembly that includes a slider, a suspension for the slider and in the case of the load/unload drive, a nose portion for directly contacting the holding ramp during the unload cycle. The slider also includes a head assembly including a magnetic read/write transducer or head for reading/writing information to or from a location on the disk. The complete assembly, e.g., the suspension and slider, is called a head gimbal assembly (HGA).

In operation, the hard disk is rotated at a set speed via a spindle motor assembly having a central drive hub. Additionally, there are tracks evenly spaced at known intervals across the disk. When a request for a read of a specific portion or track is received, the hard disk aligns the head, via the arm, over the specific track location and the head reads the information from the disk. In the same manner, when a request for a write of a specific portion or track is received, the hard disk aligns the head, via the arm, over the specific track location and the head writes the information to the disk.

Over the years, the disk and the head have undergone great reductions in their size. Much of the refinement has been driven by consumer demand for smaller and more portable hard drives such as those used in personal digital assistants (PDAs), MP3 players, and the like. For example, the original hard disk drive had a disk diameter of 24 inches. Modern hard disk drives are much smaller and include disk diameters 3.5 to 1 inches (and even smaller than 1 inch). Advances in magnetic recording are also primary reasons for the reduction in size.

However, the decreased track spacing and the overall reduction in HDD component size and weight in collusion with the load/unload drive capabilities have resulted in problems with respect to the HGA in general and the slider suspension in particular. Specifically, as the component sizes shrink, a need for tighter aerial density arises. In other words, the HGA is brought physically closer to the magnetic media. In some cases, the HGA will reach “ground zero” or contact recording. However, one of the major problems with near contact recording is the effect of vibration resonance when a portion of the HGA encounters the magnetic media or disk.

For example, when the slider contacts the disk, dynamic coupling between the slider and components of the head gimbal assembly (including the gimbal structure and nose portion) make the interface unstable and generate a strong or even a sustained slider (or even HGA) vibration. The vibration will result in slider flying height modulation thereby degrading read/write performance. This problem is particularly egregious in the load/unload drive wherein the nose limiter extending from the flexure tab (referred to herein as flexure nose) under the slider provides an additional moment arm thereby increasing the vibration characteristics. In many cases, after a disk contact, the flexure nose will enter into a resonance vibration resulting in unstable flying of the slider.

One effective method of resolving the flexure nose vibration resonance includes adding of external viscoelastic dampening material in the nose limiter and the flexure legs areas of the suspension. However, although the addition of damping material at the point of high strain is an effective solution, it also adds additional cost and time to the manufacturing of the suspension.

### SUMMARY

A method for extending and utilizing a web made out of existing flexure base material polyimide to dampen a flexure nose portion of a head gimbal assembly is disclosed. The method provides a slider coupled with the head gimbal assembly, the slider having a read/write head element thereon. In addition, a flexure nose portion is coupled with the head gimbal assembly. A suspension flexure polyimide material web is provided between the flexure nose portion and the head gimbal assembly for damping said flexure nose portion.

### BRIEF DESCRIPTION OF THE DRAWINGS

FIG. 1 is a schematic top plan view of a hard disk drive, in accordance with one embodiment of the present invention.

FIG. 2 is a side view of an exemplary actuator according to one embodiment of the present invention.

FIG. 3 is a bottom view of one exemplary head gimbal assembly with a suspension flexure polyimide material web in accordance with one embodiment of the present invention.

FIG. 4 is a bottom view of one exemplary head gimbal assembly with a stainless steel frame in accordance with one embodiment of the present invention.

FIG. 5 is a bottom view of one exemplary head gimbal assembly with a suspension flexure polyimide material web and a stainless steel frame in accordance with one embodiment of the present invention.

FIG. 6 is a flowchart of a method for utilizing a suspension flexure polyimide material web to dampen a flexure nose portion of a head gimbal assembly in accordance with one embodiment of the present invention.

FIG. 7 is a flowchart of a method for utilizing a stainless steel framework for changing the resonance frequency range of a flexure nose portion of a head gimbal assembly in accordance with one embodiment of the present invention.

### BEST MODES FOR CARRYING OUT THE INVENTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The discussion will begin with an overview of an electrical lead suspension (ELS) in conjunction with its operation within a hard disk drive and components connected therewith. The discussion will then focus on embodiments of a method for utilizing a suspension flexure polyimide material web to dampen a flexure nose portion of a head gimbal assembly in particular.

In general, embodiments of the present invention reduce the detrimental aspects of the flexure nose vibration within a hard disk drive by restricting nose motion and/or dissipating vibration energy. For example, when a flying slider contacts disk asperities the impact energy can result in vibration of the flexure nose. In some cases, the vibration of the flexure nose reaches a resonance frequency resulting in unstable flight of the slider. By reducing the flexure nose vibration, the recovery time from unstable to stable flight of the slider can be significantly reduced.

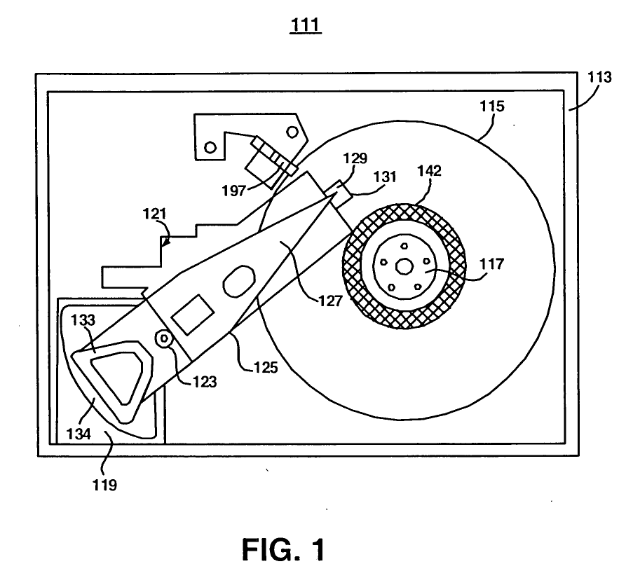

With reference now to FIG. 1, a schematic drawing of one embodiment of an information storage system comprising a magnetic hard disk file or drive 111 for a computer system is shown. Embodiments of the invention are well suited for utilization on a plurality of hard disk drives. The utilization of the driver of FIG. 1 is merely one of a plurality of disk drives that may be utilized in conjunction with the present invention. For example, in one embodiment the hard disk drive 111 would use load/unload (L/UL) techniques with a ramp 197 and a nose limiter. In another embodiment, the drive 111 is a non L/UL drive, for example, a contact start-stop (CSS) drive having a textured landing zone 142 away from the data region of disk 115.

In the exemplary FIG. 1, Drive 111 has an outer housing or base 113 containing a disk pack having at least one media or magnetic disk 115. A spindle motor assembly having a central drive hub 117 rotates the disk or disks 115. An actuator comb 121 comprises a plurality of parallel actuator arms 125 (one shown) in the form of a comb that is movably or pivotally mounted to base 113 about a pivot assembly 123. A controller 119 is also mounted to base 113 for selectively moving the comb of arms 125 relative to disk 115.

In the embodiment shown, each arm 125 has extending from it at least one cantilevered ELS 127. It should be understood that ELS 127 may be, in one embodiment, an integrated lead suspension (ILS) that is formed by a subtractive process. In another embodiment, ELS 127 may be formed by an additive process, such as a Circuit Integrated Suspension (CIS). In yet another embodiment, ELS 127 may be a Flex-On Suspension (FOS) attached to base metal or it may be a Flex Gimbal Suspension Assembly (FGSA) that is attached to a base metal layer. The ELS may be any form of lead suspension that can be used in a Data Access Storage Device, such as a HDD. A magnetic read/write transducer 131 or head is mounted on a slider 129 and secured to a flexible structure called “flexure” that is part of ELS 127. The read/write heads magnetically read data from and/or magnetically write data to disk 115. The level of integration called the head gimbal assembly is the head and the slider 129, which are mounted on suspension 127. The slider 129 is usually bonded to the end of ELS 127.

ELS 127 has a spring-like quality, which biases or presses the air-bearing surface of the slider 129 against the disk 115 to cause the slider 129 to fly at a precise distance from the disk as the disk rotates and air bearing develops pressure. ELS 127 has a hinge area that provides for the spring-like quality, and a flexing interconnect (or flexing interconnect) that supports read and write traces through the hinge area. A voice coil 133, free to move within a conventional voice coil motor magnet assembly 134 (top pole not shown), is also mounted to arms 125 opposite the head gimbal assemblies. Movement of the actuator comb 121 (indicated by arrow 135) by controller 119 causes the head gimbal assemblies to move along radial arcs across tracks on the disk 115 until the heads settle on their set target tracks. The head gimbal assemblies operate in a conventional manner and always move in unison with one another, unless drive 111 uses multiple independent actuators (not shown) wherein the arms can move independently of one another.

In general, the load/unload drive refers to the operation of the ELS 127 with respect to the operation of the disk drive. That is, when the disk 115 is not rotating, the ELS 127 is unloaded from the disk. For example, when the disk drive is not in operation, the ELS 127 is not located above the disk 115 but is instead located in a holding location on L/UL ramp 197 away from the disk 115 (e.g., unloaded). Then, when the disk drive is operational, the disk(s) are spun up to speed, and the ELS 127 is moved into an operational location above the disk(s) 115 (e.g., loaded). In so doing, the deleterious encounters between the slider and the disk 115 during non-operation of the HDD 111 are greatly reduced. Moreover, due to the movement of the ELS 127 to a secure off-disk location during non-operation, the mechanical shock robustness of the HDD is greatly increased.

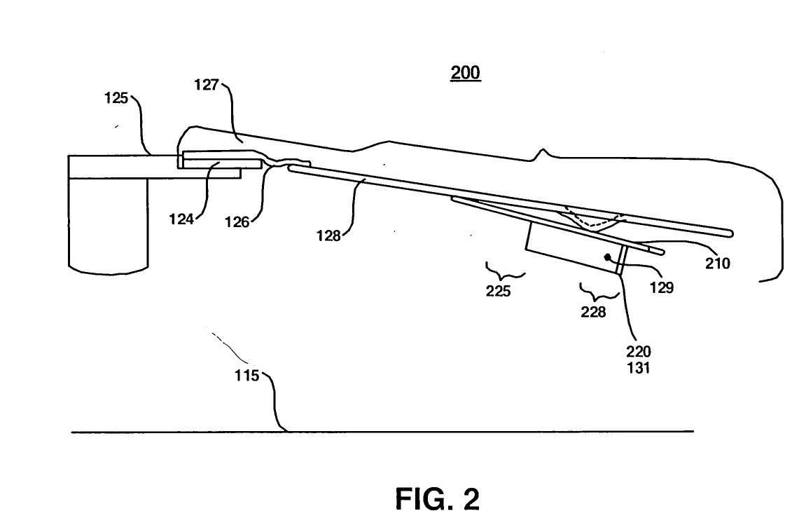

Referring now to FIG. 2, a side view of an exemplary actuator 200 is shown in accordance with one embodiment of the present invention. In one embodiment, as described herein, the actuator arm 125 has extending from it at least one cantilevered ELS 127. An ELS 127 consists of a base plate 124, hinge 126, load beam 128, electrical leads 341 and flexure 329. Based on ELS design some of these components can be combined together into one integral piece. For example hinge 126 and load beam 128 can be one piece and electrical leads 341 and flexure 210 can be one piece 329. A magnetic read/write transducer or head 220 is mounted on a slider 129 and is attached to flexible gimbal of the ELS 127. The level of integration called the head gimbal assembly (HGA) is the slider 129 carrying head 220, which is mounted on ELS 127. The slider 129 has a leading edge (LE) portion 225 and a trailing edge portion (TE) 228. The LE and TE are defined by the airflow direction. That is, the air flows from the LE to the TE. Usually, the head 220 locates at the TE portion 228 of the slider 129. A portion of an exemplary disk 115 is also shown in FIG. 2 for purposes of clarity.

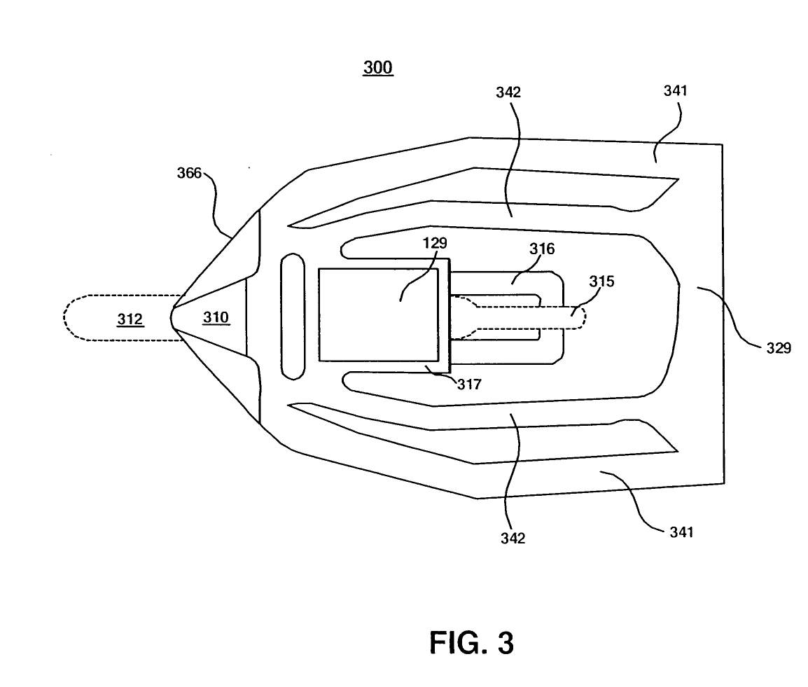

With reference now to FIG. 3, a bottom view of an exemplary head gimbal assembly (HGA) 300 is shown in accordance with one embodiment of the present invention. In one embodiment, HGA 300 includes a slider portion 129 and gimbal structure (e.g., flexure) 329. In one embodiment, gimbal structure 329 includes a flexure tongue 317, a front limiter 316, two flexible legs 342, electric connections 341 and a nose limiter 310. As is known in the art, gimbal structure 329 is utilized to flexibly suspend the head supporting slider 129 from the load beam 312. In general, the flexibility of the gimbal structure allows the slider 129 to remain flexible while flying above the disk 115. In so doing, the slider 129 will maintain a correct attitude over the disk 115 allowing the head 220 (of FIG. 2) to remain in correct alignment with the disk 115 such that the read/write capabilities of the head 220 remain constant.

HGA 300 also includes a flexure nose (or nose limiter) 310 utilized during unload times of the disk drive. That is, when the ELS 127 is moved to a secure off-disk location on L/UL ramp 197 during non-operation, the nose limiter 310 is utilized in conjunction with a staging platform to reduce unwanted motion of the gimbal structure 329. For example, on a HDD having a plurality of ELS 127, and therefore a plurality of HGA 300, during the unload state there is a need to support the gimbal structure 329 such that the sliders will not contact each other during movement of the HDD, or when the HDD experiences a shock event. By utilizing a staging platform having intimate contact with the flexure nose 310, and a front limiter 316 contact with the limiter bar 315 on the loadbeam 312, the deleterious movement of the gimbal structure 329 during unload times is greatly reduced. The front limiter 315, the flexure nose 310 and its associated staging platform (L/UL ramp 197) are well known in the art.

With reference still to FIG. 3, in one embodiment, during normal operation of the HDD, contact between the slider 129 and the disk 115 sometimes occurs. As stated herein, one of the major problems with the intermittent contact is inducing of vibrations on the flexure nose 310 of the HGA 300 when the slider 129 encounters the magnetic media or disk 115. That is, when the slider 129 contacts the disk 115, dynamic coupling between the flexure nose 310 and the gimbal structure 329 could make the slider 129 interface unstable as well as generating a strong or even a sustained vibration resonance at the flexure nose 310.

For example, the flexure nose 310 extending from the gimbal structure 329 provides an additional moment arm to the HGA 300 thereby increasing the vibration characteristics between the slider 129 and the gimbal structure 329. In other words, when the flexure nose 310 begins to vibrate the additional mass and moment arm help maintain the vibration (e.g., reaching a harmonic state) of the flexure nose 310. Generally, a very small energy can keep the vibration sustained for a prolonged length of time such that the read/write capabilities and the interface reliability are significantly impacted. That is, the flexure nose 310 vibration will result in slider 129 flying height modulation thereby degrading read/write performance, or resulting in the slider/disk interface failure. It also limits the ability to achieve the lower flying height required for higher recording density.

Referring still to FIG. 3, in one embodiment, a suspension flexure polyimide material web 366 is provided between the flexure nose and the head gimbal assembly to dampen the offending vibrations. That is, in one embodiment, by providing a suspension flexure polyimide material web 366 the vibrations associated with a disk-slider encounter are significantly reduced after the encounter occurs. In another embodiment, the suspension flexure polyimide material web 366 reduces the vibrations associated with a disk-slider encounter during the encounter.

In one embodiment, the suspension flexure polyimide material web 366 for an ILS is not added as a new component but is instead not etched away during the manufacturing of the HGA 300. For example, typical ILS HGA designs have three main materials: stainless steel as a support structure, polyimide (e.g., a polymer) as an electric isolation layer, and copper traces as electric connections. On the surface of the copper traces, there might be a golden coating layer or a cover coat (e.g., a cover layer) to provide further electric isolation.

In general, during manufacture, the shape of the ILS HGA is formed by etching each of the three (or more) layers of material thereby resulting in the final HGA design. Therefore, in one embodiment, in the area of the suspension flexure polyimide material web 366 both the stainless steel layer and the copper layer are etched away, but the polyimide layer is retained. By retaining the portion of the polyimide layer as the suspension flexure polyimide material web 366, additional damping properties can be realized by the flexure nose 310 without requiring additional manufacturing processes or materials. That is, the addition of the suspension flexure polyimide material web 366 is gained without requiring additional material costs or adversely affecting the flight characteristics of the HGA 300. In another embodiment, the suspension flexure polyimide material web 366 on a CIS is added as an additional manufacturing step.

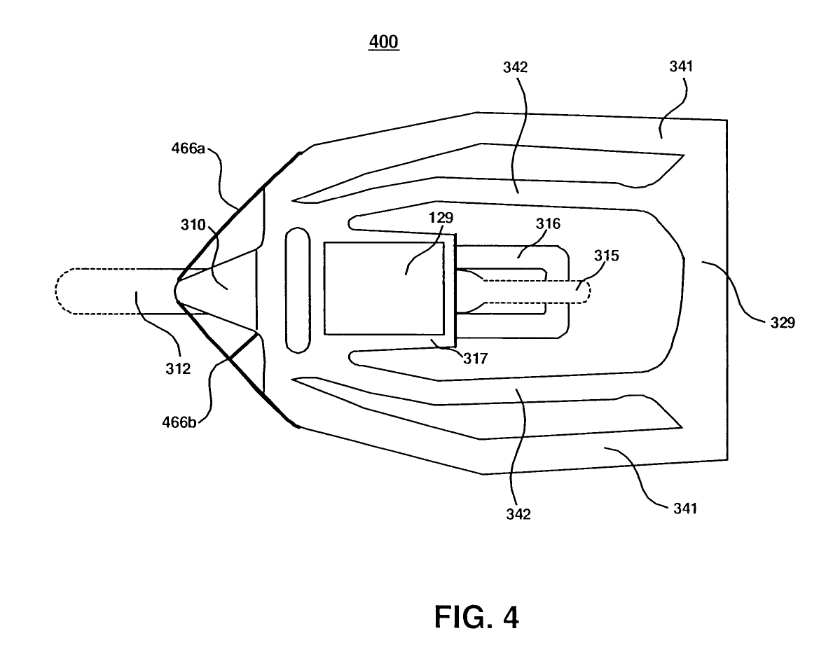

Referring now to FIG. 4, in one embodiment, a stainless steel framework 466a and/or 466b is provided between the flexure nose 310 and the HGA 300 to dampen the offending vibrations. In one embodiment, both stainless steel frameworks may be similar to that of stainless steel framework 466a. In another embodiment, if additional stiffness is desired, cross members such as those shown in stainless steel framework 466b (or other patterns) are utilized. However, for purposes of clarity and brevity, the stainless steel framework will be referred to as stainless steel framework 466a.

In one embodiment, by providing a stainless steel framework 466a the flexure nose 310 is significantly stiffened. In so doing, the associated resonant vibration realized with a disk-slider encounter is moved from the detrimental frequency range of 40-50 kHz to a higher (e.g., 52-70 kHz) non-impacting resonance frequency. In another embodiment, the stainless steel framework 466a changes the resonance frequency of the vibrations associated with a disk-slider encounter during the encounter.

In one embodiment, the stainless steel framework 466a is not added (for ILS and CIS) as a new component but is instead not etched away during the manufacturing of the HGA 300. For example, as stated herein, typical HGA designs have three main materials: stainless steel as a support structure, polyimide (e.g., a polymer) as an electric isolation layer, and copper traces as electric connections. On the surface of the copper traces, there might be a gold coating layer and/or a cover coat to provide further electric isolation.

In general, during manufacture, the shape of the ILS HGA is formed by etching each of the three (or more) layers of material thereby resulting in the final HGA design. Therefore, in one embodiment, in the area of the stainless steel framework 466a a portion of the stainless steel layer and both the polyimide layer and the copper layer are etched away. By retaining the portion of the stainless steel layer as the stainless steel framework 466a, additional stiffening properties can be realized by the flexure nose 310 without requiring additional manufacturing processes or materials or adding additional cost. That is, the addition of the stainless steel framework 466a is gained without requiring additional material costs or adversely affecting the flight characteristics of the HGA 300. In another embodiment, the stainless steel framework 466a is added as an additional manufacturing step.

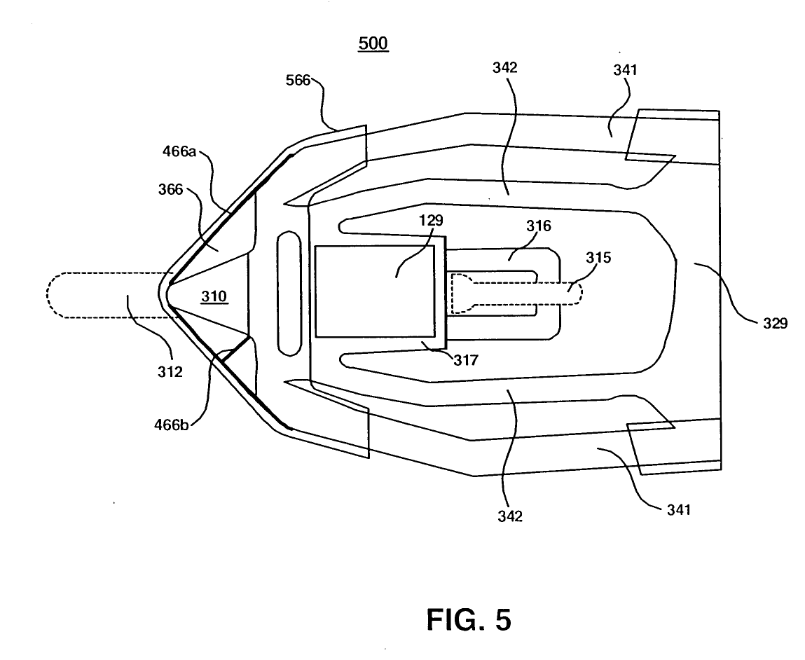

With reference now to FIG. 5, in one embodiment, both the suspension flexure polyimide material web 366 and the stainless steel framework are provided between the flexure nose 310 and the HGA 300 to counteract the offending vibrations. That is, in one embodiment, by providing a suspension flexure polyimide material web 366 the vibrations associated with a disk-slider encounter are significantly reduced after the encounter occurs. In addition, by providing a stainless steel framework 466a the flexure nose 310 is significantly stiffened. In so doing, the associated resonant vibration realized with a disk-slider encounter is moved from the detrimental frequency range of 40-50 kHz to a higher (e.g., 52-70 kHz) non-impacting resonance frequency. In another embodiment, the suspension flexure polyimide material web 366 reduces the vibrations associated with a disk-slider encounter and the stainless steel framework 466a changes the resonance frequency of the vibrations associated with a disk-slider encounter during the encounter.

In one embodiment, both the suspension flexure polyimide material web 366 and the stainless steel framework are formed during the manufacturing of the HGA 300 as described herein. In addition, a portion of the cover coat 566 is also maintained over the suspension flexure polyimide material web to provide further damping for the flexure nose 310. In another embodiment, the cover coat 566 is provided when just the suspension flexure polyimide material web 366 is utilized to further dampen the flexure nose 310 vibrations. In yet another embodiment, the cover coat 566 is provided when just the stainless steel framework is present to further dampen the flexure nose 310 vibrations.

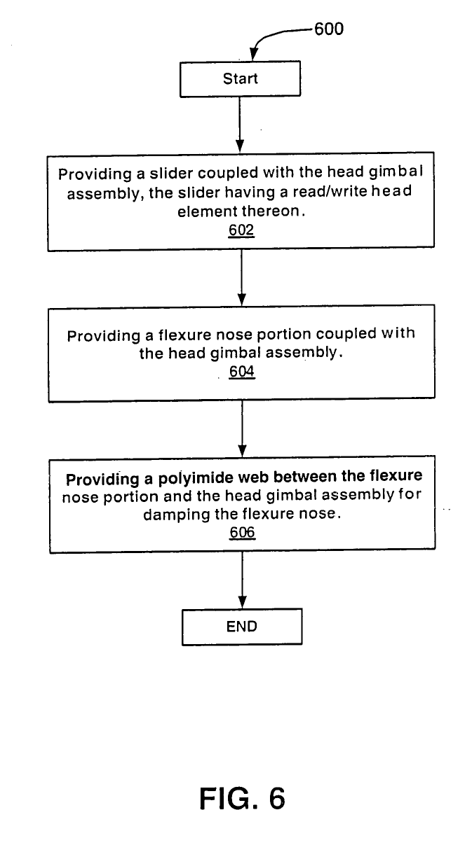

Referring now to FIG. 6 and to FIG. 3, a flowchart 600 of a method for utilizing a suspension flexure polyimide material web 366 to dampen a flexure nose portion 310 of a HGA 300 is shown in accordance with one embodiment of the present invention. In one embodiment, the hard disk drive is a contact drive, e.g., the head 220 is in contact with the disk 115. In another embodiment, the hard disk drive is a load/unload drive.

With reference now to step 602 of FIG. 6 and to FIG. 2, one embodiment provides a slider 129 coupled with the HGA 300, the slider 129 having a read/write head element thereon. In one embodiment, the head 220 is a portion of a contact recording system. That is, the head 220 is brought to “ground zero” or into contact with the disk it is over flying. In another embodiment, the head 220 has a tight aerial density and is not in contact with the disk 115 it is over flying, but is hovering just above the disk 115. In other words, although the head 220 is not designed to be in contact with the disk 115, due to the closeness with which it is flying with respect to the disk 115, intermittent contact may occur.

Referring now to step 604 of FIG. 6 and to FIG. 3, one embodiment provides a flexure nose portion 310 coupled with the HGA 300. As described herein, the flexure nose portion 310 is utilized during the unloading stage of the hard disk drive.

With reference now to step 606 of FIG. 6 and to FIG. 3, one embodiment provides a suspension flexure polyimide material web 366 between the flexure nose portion 310 and the HGA 300 for damping the flexure nose 310. As described herein, the suspension flexure polyimide material web 366 reduces coupled vibration of the slider 129 and the gimbal structure 329.

As stated herein, in one embodiment, the suspension flexure polyimide material web 366 is a portion of the polyimide layer that was not removed during the subtractive ILS manufacturing process. In another embodiment, the suspension flexure polyimide material web 366 is a portion of the polyimide layer that was added during the additive CIS manufacturing process. Therefore, the manufacturing of the HGA 300 including the suspension flexure polyimide material web 366 requires no additional materials or steps. In other words, the suspension flexure polyimide material web 366 (e.g., polyimide layer) would simply be added to (or masked during the removal process) form the desired flexure nose damping structure.

By providing the suspension flexure polyimide material web 366 around the flexure nose 310, pluralities of benefits are achieved. Specifically, a reduction in the vibration characteristics of the HGA 300 is achieved. Moreover, the amplitude of the frequency response function, e.g., the slider vertical vibration at trailing edge center to the contact force at the same location, is greatly reduced. For example, without the suspension flexure polyimide material web 366, the HGA 300 shows strong responses with respect to a slider-disk contact. These responses are strongest at 48 kHz, 150 kHz and 180 kHz in one exemplary embodiment.

However, with the addition of the suspension flexure polyimide material web 366, the HGA 300 responses across the frequency spectrum are greatly reduced. That is, the suspension flexure polyimide material web 366 allows the HGA 300 to recover from a slider-disk contact and the following induced vibrations at a significantly faster rate. Therefore, instead of the vibrations becoming sustained, the suspension flexure polyimide material web 366 allows the vibration to be removed from the HGA 300 bringing the HGA 300 to within operational limitations. Therefore, the suspension flexure polyimide material web 366 is an effective way to improve head-disk interface dynamics.

In another embodiment, a cover coat 566 of FIG. 5 is provided over the suspension flexure polyimide material web 366 to provide further damping to the flexure nose 310. In yet another embodiment, the stainless steel framework (e.g., 466a or 466b) is utilized in conjunction with the suspension flexure polyimide material web 366 to also stiffen the flexure nose 310. In a further embodiment, all three layers (e.g., the stainless steel framework, suspension flexure polyimide material web and cover coat) are provided as the structure around flexure nose 310.

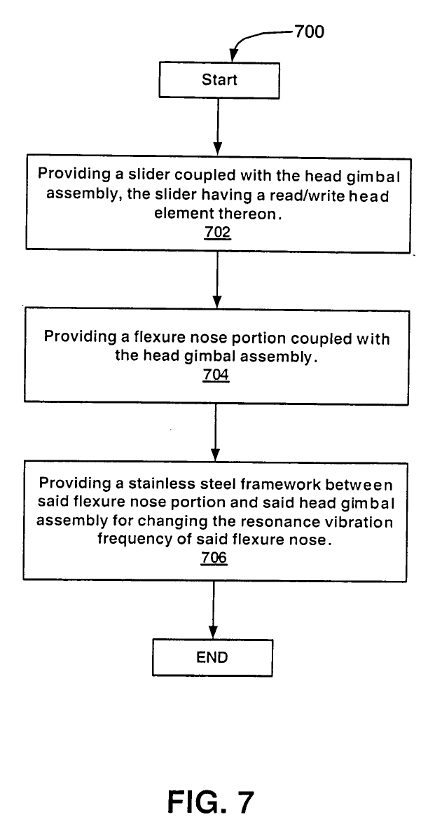

Referring now to FIG. 7 and to FIG. 2, a flowchart 700 of a method for utilizing a stainless steel framework (e.g., 466a or 466b) for changing the resonance frequency range of a flexure nose portion of a HGA 300 is shown in accordance with one embodiment of the present invention. In one embodiment, the hard disk drive is a near contact drive, e.g., the head 220 is in intermittent contact with the disk 115. In another embodiment, the hard disk drive is a load/unload drive.

With reference now to step 702 of FIG. 7 and to FIG. 2, one embodiment provides a slider 129 coupled with the HGA 300, the slider 129 having a read/write head element thereon. In one embodiment, the head 220 is a portion of a contact recording system. That is, the head 220 is brought to “ground zero” or into contact with the disk it is over flying. In another embodiment, the head 220 has a tight aerial density and is not in contact with the disk 115 it is over flying, but is hovering just above the disk 115. In other words, although the head 220 is not designed to be in contact with the disk 115, due to the closeness with which it is flying with respect to the disk 115, intermittent contact may occur.

Referring now to step 704 of FIG. 7 and to FIG. 3, one embodiment provides a flexure nose portion 310 coupled with the HGA 300. As described herein, the flexure nose portion 310 is utilized during the unloading stage of the hard disk drive.

With reference now to step 706 of FIG. 7 and to FIG. 4, one embodiment provides a stainless steel framework (e.g., 466a or 466b) between the flexure nose portion 310 and the HGA 300 for stiffening the flexure nose 310. As described herein, the stainless steel framework (e.g., 466a or 466b) reduces coupled vibration of the slider 129 and the gimbal structure 329.

As stated herein, in one embodiment, the stainless steel framework (e.g., 466a or 466b) is a portion of the stainless steel layer that was not removed during the subtractive ILS manufacturing process. In another embodiment, the stainless steel framework (e.g., 466a or 466b) is a portion of the stainless steel layer that was added during the additive CIS manufacturing process. Therefore, the manufacturing of the HGA 300 including the stainless steel framework (e.g., 466a or 466b) requires no additional materials or steps. In other words, the stainless steel framework (e.g., 466a or 466b) would simply be added to (or masked during the removal process) form the desired flexure nose stiffening structure.

By providing the stainless steel framework (e.g., 466a or 466b) around the flexure nose 310, pluralities of benefits are achieved. Specifically, a reduction in the vibration characteristics of the HGA 300 is achieved. Moreover, the amplitude of the frequency response function, e.g., the slider vertical vibration at trailing edge center to the contact force at the same location, is greatly reduced. For example, without the stainless steel framework (e.g., 466a or 466b), the HGA 300 shows strong responses with respect to a slider-disk contact. These responses are strongest at 48 kHz, 150 kHz and 180 kHz in one exemplary embodiment.

However, with the addition of the stainless steel framework (e.g., 466a or 466b), the HGA 300 responses across the frequency spectrum are greatly reduced. That is, the stainless steel framework (e.g., 466a or 466b) allows the HGA 300 to recover from a slider-disk contact and the following induced vibrations at a significantly faster rate. Therefore, instead of the vibrations becoming sustained, the stainless steel framework (e.g., 466a or 466b) allows the vibration to be removed from the HGA 300 bringing the HGA 300 to within operational limitations. Therefore, the stainless steel framework (e.g., 466a or 466b) is an effective way to improve head-disk interface dynamics.

In another embodiment, a cover coat 566 of FIG. 5 is provided over the stainless steel framework (e.g., 466a or 466b) to provide further damping to the flexure nose 310. In yet another embodiment, the suspension flexure polyimide material web 366 is utilized in conjunction with the stainless steel framework (e.g., 466a or 466b) to also further damp the flexure nose 310. In a further embodiment, all three layers (e.g., the stainless steel framework, suspension flexure polyimide material web and cover coat) are provided as the structure around flexure nose 310.

Thus, embodiments of the present invention provide, a method for utilizing a suspension flexure polyimide material web to dampen a flexure nose portion of a head gimbal assembly. Additionally, embodiments provide a method for utilizing a suspension flexure polyimide material web to dampen a flexure nose portion of a head gimbal assembly that can reduce the vibrations resulting from when the slider contacts the disk portion during a disk-slider encounter. Moreover, embodiments provide a method for utilizing a suspension flexure polyimide material web to dampen a flexure nose portion of a head gimbal assembly that is compatible with present manufacturing techniques resulting in little or no additional costs.

While the method of the embodiment illustrated in flow charts 600 and 700 show specific sequences and quantity of steps, the present invention is suitable to alternative embodiments. For example, not all the steps provided for in the methods are required for the present invention. Furthermore, additional steps can be added to the steps presented in the present embodiment. Likewise, the sequences of steps can be modified depending upon the application.

The alternative embodiment(s) of the present invention are thus described. While the present invention has been described in particular embodiments, it should be appreciated that the present invention should not be construed as limited by such embodiments, but rather construed according to the below claims.

What is claimed is:

1. A method for utilizing a suspension flexure polyimide material web to dampen a flexure nose portion of a head gimbal assembly comprising:
providing a slider coupled with said head gimbal assembly, said slider having a read/write head element thereon;
providing a flexure nose portion coupled with said head gimbal assembly; and
providing a suspension flexure polyimide material web between said flexure nose portion and said head gimbal assembly for damping said flexure nose portion.

2. The method of claim 1 further comprising:
extending said suspension flexure polyimide material web on each side of said flexure nose portion to a shoulder portion of said head gimbal assembly.

3. The method of claim 1 wherein said head gimbal assembly is a portion of a load/unload hard disk drive assembly.

4. The method of claim 1 wherein providing said suspension flexure polyimide material web comprises:
extending a portion of existing flexure base material polyimide to form the suspension flexure polyimide material web between said flexure nose portion and said head gimbal assembly.

5. The method of claim 1 further comprising:
providing a cover coat above said suspension flexure polyimide material web for damping said flexure nose portion.

6. The method of claim 5 wherein providing said cover coat comprises:
extending a portion of a suspension cover coat to form the cover coat above said suspension flexure polyimide material web of the nose.

7. The method of claim 1 further comprising:
providing a stainless steel framework coupled with said suspension flexure polyimide material web for changing the resonance vibration frequency of said flexure nose portion.

8. The method of claim 7 wherein providing said stainless steel framework comprises:
extending a portion of a suspension flexure stainless steel layer to form the stainless steel framework.

9. A method for utilizing a suspension flexure polyimide material web to dampen a flexure nose portion of a head gimbal assembly comprising:
providing a slider coupled with said head gimbal assembly, said slider having a read/write head element thereon;
providing a flexure nose portion coupled with said head gimbal assembly;
providing a suspension flexure polyimide material web between said flexure nose portion and said head gimbal assembly for damping said flexure nose portion; and
providing a cover coat above said suspension flexure polyimide material web for further damping of said flexure nose portion.

10. The method of claim 9 further comprising:
extending said suspension flexure polyimide material web on each side of said flexure nose portion to a shoulder portion of said head gimbal assembly.

11. The method of claim 9 further comprising:
extending said cover coat on each side of said flexure nose portion to a shoulder portion of said head gimbal assembly.

12. The method of claim 9 wherein said head gimbal assembly is a portion of a load/unload hard disk drive assembly.

13. The method of claim 9 wherein providing said suspension flexure polyimide material web comprises:
extending a portion of a suspension flexure material polyimide layer to form the suspension flexure polyimide material web between said flexure nose portion and said head gimbal assembly.

14. The method of claim 9 wherein providing said cover coat comprises:
extending a portion of a suspension flexure material cover coat to form the cover coat above said suspension flexure polyimide material web.

15. The method of claim 9 further comprising:
providing a stainless steel framework coupled with said suspension flexure polyimide material web for changing the resonance vibration frequency of said flexure nose portion.

16. The method of claim 15 wherein providing said stainless steel framework comprises:
extending a portion of a suspension flexure material stainless steel layer to form the stainless steel framework.

17. A method for utilizing a suspension flexure polyimide material web to dampen a flexure nose portion of a head gimbal assembly comprising:
providing a slider coupled with said head gimbal assembly, said slider having a read/write head element thereon;
providing a flexure nose portion coupled with said head gimbal assembly;
providing a suspension flexure polyimide material web between said flexure nose portion and said head gimbal assembly for damping said flexure nose portion; and
providing a stainless steel framework coupled with said suspension flexure polyimide material web for changing the resonance vibration frequency of said flexure nose portion.

18. The method of claim 17 further comprising:
extending said suspension flexure polyimide material web on each side of said flexure nose portion to a shoulder portion of said head gimbal assembly.

19. The method of claim 17 further comprising:
extending said stainless steel framework on each side of said flexure nose portion to a shoulder portion of said head gimbal assembly.

20. The method of claim 17 wherein said head gimbal assembly is a portion of a load/unload hard disk drive assembly.

21. The method of claim 17 wherein providing said suspension flexure polyimide material web comprises:
extending a portion of a suspension flexure material polyimide layer to form the suspension flexure polyimide material web between said flexure nose portion and said head gimbal assembly.

22. The method of claim 17 further comprising:
providing a cover coat above said suspension flexure polyimide material web for further damping of said flexure nose portion.

23. The method of claim 22 wherein providing said cover coat comprises:
extending a portion of a suspension flexure material cover coat to form the cover coat above said suspension flexure polyimide material web.

24. The method of claim 17 wherein providing said stainless steel framework comprises:
extending a portion of the suspension flexure material stainless steel layer to form the stainless steel framework.

25. A suspension flexure polyimide material web for damping a flexure nose portion of a head gimbal assembly comprising:
a means for providing a slider coupled with said head gimbal assembly, said slider having a read/write head element thereon;
a means for providing a flexure nose portion coupled with said head gimbal assembly; and
a means for providing a suspension flexure polyimide material web between said flexure nose portion and said head gimbal assembly for damping said flexure nose portion.
